(19) United States
(12) Patent Application Publication
(10) Pub. No.: US 2024/0315194 A1
(43) Pub. Date: Sep. 26, 2024

(54) FOLDABLE PET ENCLOSURE

(71) Applicant: Doskocil Manufacturing Company, Inc., Arlington, TX (US)

(72) Inventors: Jill JACKSON, Arlington, TX (US); Josiah WILHELM, Arlington, TX (US)

(21) Appl. No.: 18/124,368

(22) Filed: Mar. 21, 2023

(51) Int. Cl. A01K 1/03

(52) U.S. Cl. CPC A01K 1/033; A01K 1/03

(57) ABSTRACT

A foldable pet enclosure includes a main section and a roof section. The main section defines a pair of side walls, a pair of end walls and a bottom wall. The pair of side walls are attached to opposite sides of the bottom wall by first hinge areas and the pair of end walls are attached to opposite ends of the bottom wall by second hinge areas. The roof section is dimensioned to fit atop the main section with the pair of side walls folded upward along the first hinge areas from the bottom wall and with the pair of end walls folded upward along the second hinge areas from the bottom wall.

### BACKGROUND

### Technical Field

The present disclosure generally relates to a foldable pet enclosure. More specifically, the present disclosure relates to pet enclosure that can be folded to form a small box for shipping and/or storage and then open and unfolded to form the pet enclosure with a separate roof panel.

### Background Information

Pet enclosures with openings provide a space where a pet can go to feel safe and comfortable. Most pet enclosures take up floor space when not in use and typically take up storage space when not in use. Further pet enclosures are typically placed in a correspondingly shaped box for shipping and storage in a warehouse, also taking up considerable space.

### SUMMARY

It has been discovered that a folding pet enclosure takes up little space when folded up making storage and shipping less of a burden.

In view of the state of the known technology, one aspect of the present disclosure is to provide a foldable pet enclosure with a main section and a roof section. The main section defines a pair of side walls, a pair of end walls and a bottom wall. The pair of side walls are attached to opposite sides of the bottom wall by first hinge areas and the pair of end walls are attached to opposite ends of the bottom wall by second hinge areas. The roof section is dimensioned to fit atop the main section with the pair of side walls folded upward along the first hinge areas from the bottom wall and with the pair of end walls folded upward along the second hinge areas from the bottom wall thereby defining an enclosure.

### BRIEF DESCRIPTION OF THE DRAWINGS

Referring now to the attached drawings which form a part of this original disclosure:

FIG. 1 is a perspective view of a foldable pet enclosure that includes a main section and a roof section in accordance with an exemplary embodiment;

FIG. 2 is a perspective view of a box formed by folding the main section of foldable pet enclosure with side walls of the foldable pet enclosure defining a lid of the box in accordance with the exemplary embodiment;

FIG. 3 is a second perspective view of the box depicted in FIG. 2 with the side walls of the foldable pet enclosure folded outward revealing an inside of the box and showing a front wall and a rear wall of the main section of foldable pet enclosure folded to fit within the box in accordance with the exemplary embodiment;

FIG. 4 is a third perspective view of the box depicted in FIGS. 2 and 3 with the side walls folded outward and the front and rear walls also folded outward revealing the roof section folded and stored within the box in accordance with the exemplary embodiment:

FIG. 5 is a perspective view of the roof section removed from the box showing the roof panel partially unfolded in the shape of a roof for the foldable pet enclosure in accordance with the exemplary embodiment;

FIG. 6 is a fourth perspective view of the box depicted in FIGS. 2-4 with the side walls folded outward, the front and rear walls folded outward and the roof section removed revealing a pair of cushions stored within the box in accordance with the exemplary embodiment;

FIG. 7 is a perspective view of the cushions removed from the box in accordance with the exemplary embodiment;

FIG. 8 is a fifth perspective view of the box depicted in FIGS. 2-4 and 6 with the side walls folded outward, the front and rear walls folded outward, the roof section removed, and the pair of cushions removed from the box showing the box emptied of all items in accordance with the exemplary embodiment;

FIG. 9 is a perspective view of the main section with the side walls folded upward, the front and rear walls folded upward and the roof section placed atop the side walls and the front and rear walls thereby defining a basic enclosure without a roof with the pair of cushions placed along the bottom of the basic enclosure in accordance with the exemplary embodiment:

FIG. 10 is another perspective view of the main section defining the basic enclosure with the roof section being placed atop the basic enclosure in accordance with the exemplary embodiment;

FIG. 11 is a top view of a sheet of material with the main section outlined and cut out of the sheet material in accordance with the exemplary embodiment; and

FIG. 12 is a top view of another sheet of material with the roof section outlined and cut out of the sheet material in accordance with the exemplary embodiment;

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

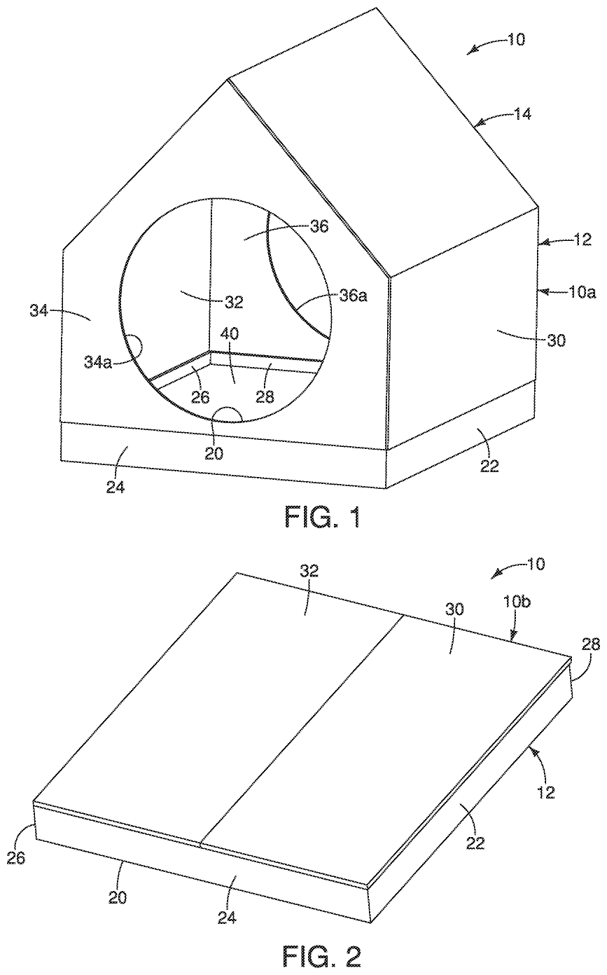

Referring initially to FIGS. 1 and 2, a foldable pet enclosure 10 is illustrated in accordance with an exemplary embodiment. The foldable pet enclosure 10 (hereinafter referred to as the pet enclosure 10) has two parts, a main section 12 and a roof section 14. The roof section 14 can be removed from the main section 12. The main section 12 can be folded to define an enclosure 10a as shown in FIG. 1 or folded to define a box 10b as shown in FIG. 2, as is described further below. When new, the pet enclosure 10 can be sold as the box 10b that includes the roof section 14 stored within the box 10b. The box 10b can thereafter be unfolded to form the main section 12 of the pet enclosure 10. Thereafter, the roof section 14 can be placed thereon.

The main section 14 has a bottom wall 20, lower wall portions 22, 24, 26 and 28, side walls 30 and 32, a front wall 34 (an end wall) and a rear wall 36 (an end wall).

With the main section 12 folded to define the enclosure 10a, the lower wall portion 22 and the side wall 30 define one side of the enclosure 10a. The lower wall portion 24 and the front wall 34 define a front side of the enclosure 10a. The lower wall portion 26 and the side wall 32 define a side of the enclosure 10a opposite the side wall 30. The lower wall portion 28 and the rear wall 36 define a back or rear side of the enclosure 10a opposite the front wall 34. As shown in FIG. 1, the front wall 34 and the rear wall 36 are provided with openings 34a and 36a, respectively.

As shown in FIG. 2, with the main section 12 folded to define the box 10b, the lower wall portion 22, 24, 26 and 28 along with the bottom wall 20 define the bottom and side walls of the box 10b. Further, with the main section 12 folded to define the box 10b, the side walls 30 and 32 fold over the upper area of the box 10b to form a top or lid to the box 10b.

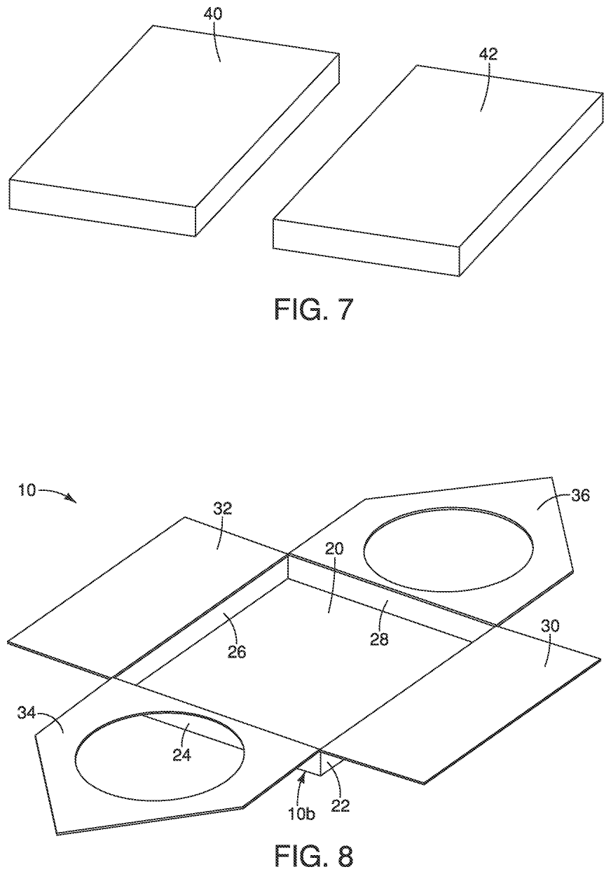

FIGS. 2-10 show the sequence of unfolding sections of the main section 14 in order to convert the box 10b into the enclosure 10a. When folded to the box 10b, the side walls 30 and 32 define a lid to the box 10b. The lower wall portions 22, 24, 26 and 28 define the four sides of the box 10b. Further, the bottom wall 20 defines a bottom of the box 10b (see FIG. 7).

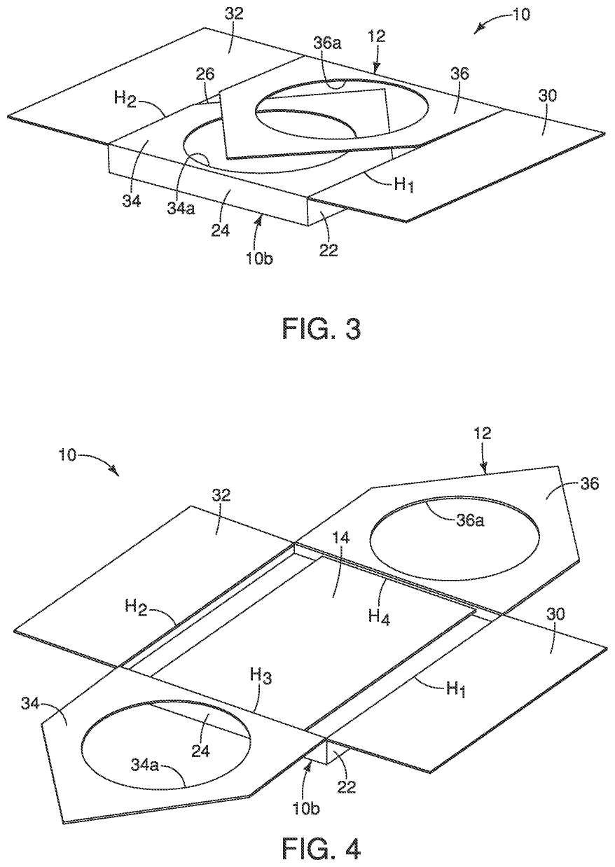

As shown in FIG. 3, in order to open the box 10b the side walls 30 and 32 (the lid of the box 10a) are folded outward or pivoted about hinge areas H₁ and H₂. Once the side walls 30 and 32 are folded or pivoted outward and away from the inside of the box 10b, a portion of the front wall 34 and all of the rear wall 36 are exposed, as shown in FIG. 3.

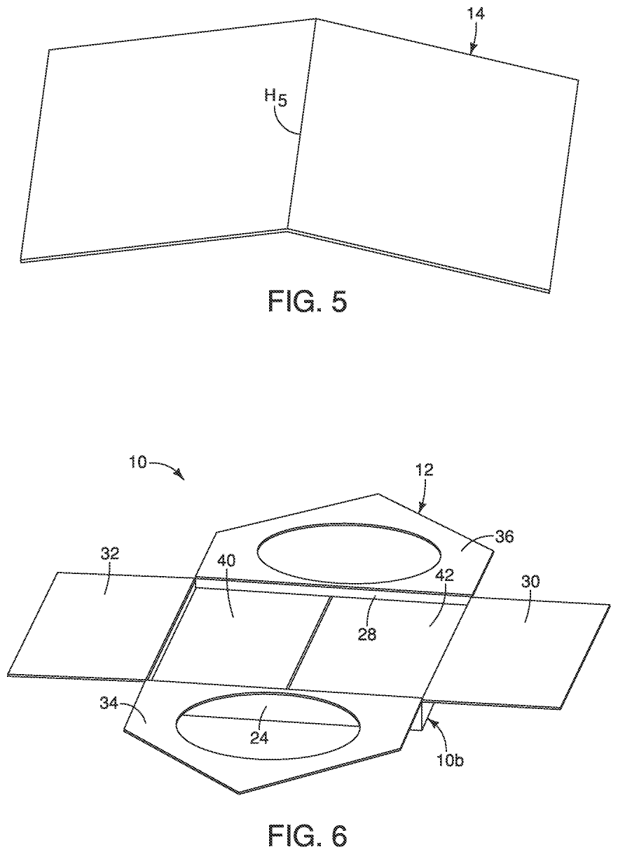

As shown in FIG. 4, the front wall 34 and the rear wall 36 are folded outward or pivoted about hinge areas H₃ and H₄. Once the front wall 34 and the rear wall 36 are folded or pivoted outward and away from the inside of the box 10b, the roof section 14 is exposed, as shown in FIG. 4. As shown in FIG. 5, the roof section 14 can be removed from the box 10b and bent about a hinge area H₅ in order to achieve the shape of a gable roof. As shown in FIG. 4, the main section 12 is foldable into the box-like shape (the box 10b) and is dimensioned to receive and retain the roof section 14 with the roof section 14 in a folded state.

With the roof section 14 removed from the box 10b, cushions 40 and 42 are exposed, as shown in FIG. 6. As shown in FIG. 7, the cushions 40 and 42 can be removed from the box 10b.

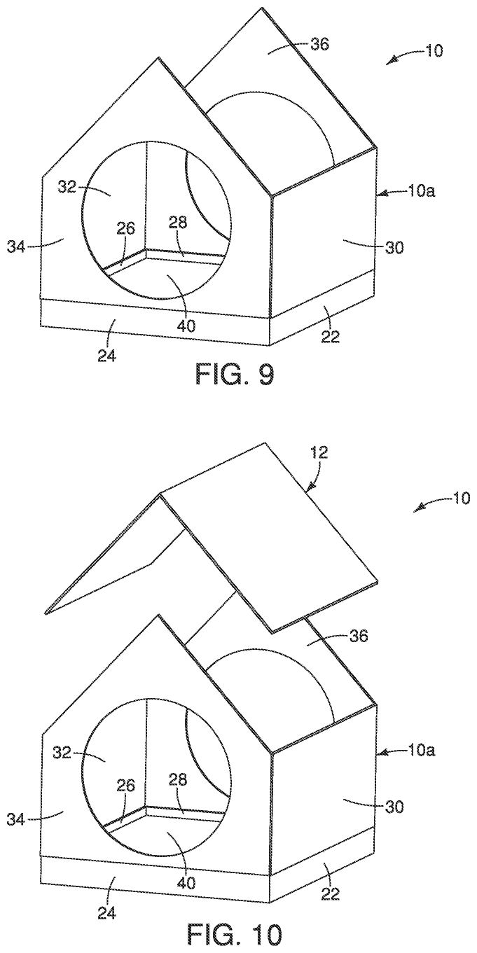

As shown in FIG. 8, the box 10b is shown fully opened and empty. The basic shape and lower section of the box 10b is defined by the bottom wall 20 and the lower wall portions 22, 24, 26 and 28. As shown in FIG. 9, the cushions 40 and 42 (not visible in FIG. 9), the side walls 30 and 32 are pivoted upward and the front and rear walls 34 and 36 are likewise pivoted upward to define the enclosure 10a without the roof section 14.

As shown in FIGS. 1, 4, 6 and 8-10, the upper edges of each of the front and rear walls 34 and 36 include angled edges that define gable walls that are pitched to receive the roof section 14.

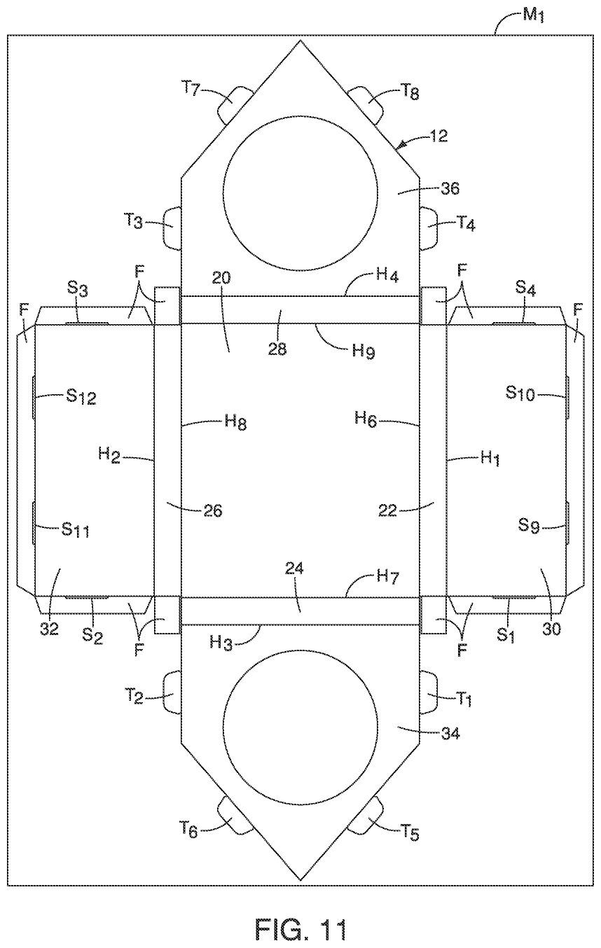

As shown in FIG. 10, the roof section 14 is installed to the gable ends of the front and rear walls 34 and 36. The roof section 14 is dimensioned to fit atop the main section 12 with the pair of side walls folded upward from the bottom wall and with the pair of end walls (the front and rear walls 34 and 36) folded upward from the bottom wall thereby defining the enclosure 10.

As shown in FIG. 8, the bottom wall 20 defines the bottom of the box 10b. As shown in FIGS. 9 and 10, the bottom wall 20 also defines the bottom or floor of the enclosure 10a.

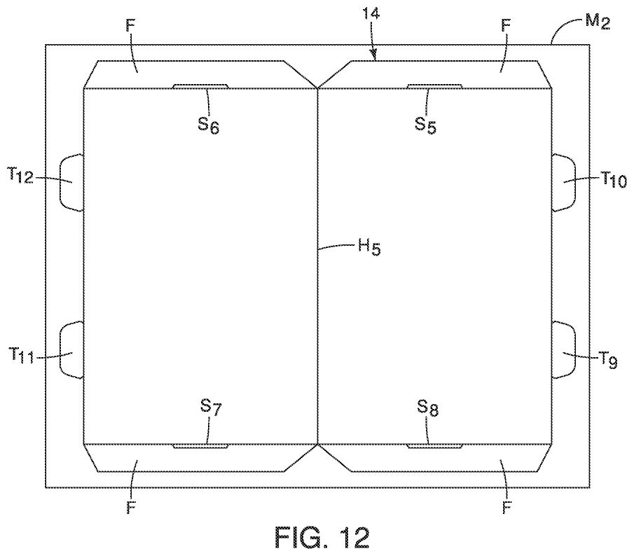

The main section 12 and the roof section 14 can be made of any of a variety of materials. For example, the main section 12 and the roof section 14 can each be made of cardboard or corrugated paper based board, such as those shown in FIGS. 1I and 12.

FIG. 11 shows a sheet of cardboard material M₁ that has been stamped, die-cut or laser-cut to “cutout” the main section 12 as a single monolithic unitary panel or element. As shown in FIG. 11, the bottom wall 20, the lower wall portions 22, 24, 26 and 28, the upper side walls 30 and 32, the front wall 34 and the rear wall 36 are clearly defined. As is also shown in FIG. 11, hinge areas H₁-H₄ and H₆₋₉ (also simply referred to as hinges) are defined by pressed lines in predetermined areas of the sheet of cardboard material M₁. As shown in FIG. 12, a hinge area H₅ is similarly pressed at the center of another sheet of cardboard material M₂ that forms or defines the roof section 14.

More specifically, the hinge H₁ is formed between the lower wall portion 22 and the side wall 30. The hinge H₂ is formed between the lower wall portion 26 and the side wall 32. The hinge H₃ is formed between the lower wall portion 24 and the front wall 34. The hinge H₄ is formed between the lower wall portion 28 and the rear wall 36.

Further, the hinge H₇ is formed between the lower wall portion 22 and the bottom wall 20. The hinge H₇ is formed between the lower wall portion 24 and the bottom wall 20. The hinge H₈ is formed between the lower wall portion 26 and the bottom wall 20. The hinge H₉ is formed between the lower wall portion 28 and the bottom wall 20.

In the depicted embodiment shown in FIGS. 11 and 12, the hinges H₁-H₉ are formed by pressing corresponding portions of the sheet materials M₁ and M₂. Alternatively, the hinges H₁-H₉ can be made of a separate material, such as a plastic or polymer sheet material, that is adhered to a plurality of separate sheets of material that define each of the bottom wall 20, the lower wall portions 22, 24, 26 and 28, the upper side walls 30 and 32, the front wall 34, the rear wall 36 and two sheets of material that define the roof section 14. In this alternative configuration, the bottom wall 20, the lower wall portions 22, 24, 26 and 28, the upper side walls 30 and 32, the front wall 34, the rear wall 36 and two sheets of material that define the roof section 14 can be made of, for example, plastic or polymer sheet materials or metallic sheets of material coated with a decorative patterned material. Further, the bottom wall 20, the lower wall portions 22, 24, 26 and 28, the upper side walls 30 and 32, the front wall 34, the rear wall 36 and two sheets of material that define the roof section 14 can alternatively be made of laminated materials to form the individual separate panels of the pet enclosure 10.

The hinges H₁-H₉ can be living hinges where no mechanical structures define the hinges. Rather, the hinges H₁-H₉ are made or formed of a thin material that is very flexible, whereas the panel portions or panels that define the bottom wall 20, the lower wall portions 22, 24, 26 and 28, the upper side walls 30 and 32, the front wall 34, the rear wall 36 and two sheets of material that define the roof section 14 are made of a stiff material that does not readily bend or lend itself to being folded. Alternatively, the hinges H₁-H₉ can be made of mechanical element with, for example two narrow thin panels of metal (not shown) that pivot about an elongated pin or shaft (not shown) with the two narrow thin panels being adhered or mechanically attached to adjacent panels that define the bottom wall 20, the lower wall portions 22, 24, 26 and 28, the upper side walls 30 and 32, the front wall 34, the rear wall 36 and two sheets of material that define the roof section 14.

As shown in FIGS. 1 and 10, the roof section 14 is shown to be dimensioned to fit atop the main section 12 with the pair of side walls 30 and 32 folded upward along the hinge areas H₁ and H₂ from the bottom wall 20 and with the front wall 34 and the rear wall 36 (the pair of end walls) folded upward along the hinge areas H₃ and H₄ from the bottom wall 20 thereby defining the enclosure 10a.

As is shown in FIG. 11, the bottom wall 20, and each of the side walls 30 and 32 have an overall rectangular shape.

The lower wall portions 22, 24, 26 and 28 are bent or folded upward from the bottom wall 20 along hinges H₆, H₇, H₈ and H₉ to form the bottom and side walls of the box 10b.

The main section 12 of the enclosure 10 can be made from any one of the following materials: paperboard, fiberboard and cardstock.

Alternatively, the various panels of the main section 12 can include laminated plastic and separate living hinges. Further, the main section 12 can includes one or more panels made from a plastic sheet material.

The hinge areas can be formed as compressed fold lines formed in the main section 12.

As shown in FIG. 11, the main section 12 can optionally further include a plurality flaps F, a plurality of tabs T₁ thru T₈ and a plurality of slots S₁ thru S₈. For example, if the main section 12 is made of cardboard or similar material, then the flaps F, the tabs T₁ thru T₈ and the slots S₁ thru S₈ can be used during the folding and assembling steps to retain the main section 12 in the shape of the enclosure 10a. Specifically, the flaps F can provide overlapping surfaces to which an adhesive can be attached in order to permanently retain the main section 12 in the shape of the enclosure 10a. Further, the tab T₁ extending from an edge of the front wall 34 can be inserted into the slot S₁, formed between the side wall 30 and the adjacent flap F; the tab T₂ extending from an opposite edge of the front wall 34 can be inserted into the slot S₂, formed between the side wall 32 and the adjacent flap F. Similarly, the tabs T₃ and T₄ of the rear wall 36 can be inserted into the slots S₃ and S₄, respectively, along opposite edges of the side walls 32 and 30, respectively. Further, the tabs T₅, T₆, T₇ and T₈ can be fitted into corresponding slots S₅, S₆, S₇ and S₈ of the roof section 14 shown in FIG. 12.

The embodiments of pet enclosure set forth in this disclosure provide a folding pet enclosure takes up little space when folded up making storage and shipping less of a burden. Moreover, the embodiments of pet enclosure set forth in this disclosure reduce shelf space within a retail environment thus reducing cost of display and increasing the number of product that can be displayed within a predetermined area.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the foldable pet enclosure. Accordingly, these terms, as utilized to describe the present invention should be interpreted relative to a vehicle equipped with the foldable pet enclosure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A foldable pet enclosure, comprising:
a main section defining a pair of side walls, a pair of end walls and a bottom wall, the pair of side walls being attached to opposite sides of the bottom wall by first hinge areas and the pair of end walls being attached to opposite ends of the bottom wall by second hinge areas; and
a roof section dimensioned to fit atop the main section with the pair of side walls folded upward along the first hinge areas from the bottom wall and with the pair of end walls folded upward along the second hinge areas from the bottom wall thereby defining an enclosure.

2. A foldable pet enclosure according to claim 1, wherein
the main section is foldable into a box-like shape dimensioned to receive and retain the roof section with the roof section in a folded state.

3. A foldable pet enclosure according to claim 1, wherein
with the main section folded to define the enclosure each of pair of end walls defines a gable wall of the enclosure.

4. A foldable pet enclosure according to claim 3, wherein
each of pair of side walls have an overall rectangular shape.

5. A foldable pet enclosure according to claim 3, wherein
the roof section defines a gabled roof of the enclosure when installed atop the gable walls.

6. A foldable pet enclosure according to claim 1, wherein
each of the pair of side walls includes a third hinge area spaced apart from the first hinge areas, and
each of the pair of end walls includes a fourth hinge areas spaced apart from the second hinge areas such that with the pair of side walls folded along the first and third hinge areas and the pair of side walls folded along the second and fourth hinge areas the main section defines a box.

7. A foldable pet enclosure according to claim 1, wherein
each of pair of side walls have an overall rectangular shape.

8. A foldable pet enclosure according to claim 1, wherein
the main section is a single monolithic unitary panel bendable along the hinge areas that distinguish the bottom wall from the pair of side walls and the pair of end walls.

9. A foldable pet enclosure according to claim 8, wherein
the hinge areas are living hinges.

10. A foldable pet enclosure according to claim 1, wherein
the main section and the roof section areas made of corrugated cardboard.

11. A foldable pet enclosure according to claim 1, wherein
the main section consists of one of the following group of materials: paperboard, fiberboard and cardstock.

12. A foldable pet enclosure according to claim 1, wherein
the main section includes laminated plastic.

13. A foldable pet enclosure according to claim 1, wherein
the main section includes a panel of a plastic sheet material.

14. A foldable pet enclosure according to claim 1, wherein
the first and second hinge areas are compressed fold lines formed in the main section.

15. A foldable pet enclosure according to claim 1, wherein
the first and second hinge areas are living hinges.
